(19) United States
(12) Patent Application Publication
(10) Pub. No.: US 2015/0159697 A1
(43) Pub. Date: Jun. 11, 2015

(54) OIL RETAINING RING

(71) Applicant: SIEMENS AKTIENGESELLSCHAFT, 80333 München (DE)

(72) Inventors: Rocco Fischer, Annaberg-Buchholz (DE); Thomas Steubler, Lugau/Erzgebiet (DE)

(21) Appl. No.: 14/406,985

(22) PCT Filed: Jun. 13, 2013
(86) PCT No.: PCT/EP2013/062239

§ 371 Date: Dec. 10, 2014

(30) Foreign Application Priority Data
Jun. 15, 2012 (EP) 12172105.4

(51) Int. Cl. F16C 33/66; F16C 33/80

(52) U.S. Cl. CPC F16C 33/6651; F16C 33/80

(57) ABSTRACT

The invention relates to a method for producing an oil retaining ring (1), and to an oil retaining ring (1). The method comprises the following steps: primary forming of a blank, which has a groove (43) intended as an oil runout, with an oil retaining edge formed in the groove (43); machining the blank on at least one circumferential surface (2) and/or at least one plane surface (3, 12) to form a finished part (1) with predetermined diameters (dᵢ, dₘ) or plane surfaces (3, 12); and leaving the groove (43) intended as an oil runout in the state obtained by primary forming on the finished part (1).

The present invention relates to an oil retaining ring and to a method for producing said ring.

A defined oil level can be set in a shaft bearing by means of a metal oil retaining plate.

EP 2574826 A1 (GKN Driveline Köping) 04.03.2013 describes in FIG. 3 an oil retaining ring 12 embodied as a press-in bush, which, by forming an oil sump in the area of a rotary bearing 11, ensures that sufficient oil for its lubrication is available to this bearing 11 even in the event of an interrupted oil flow.

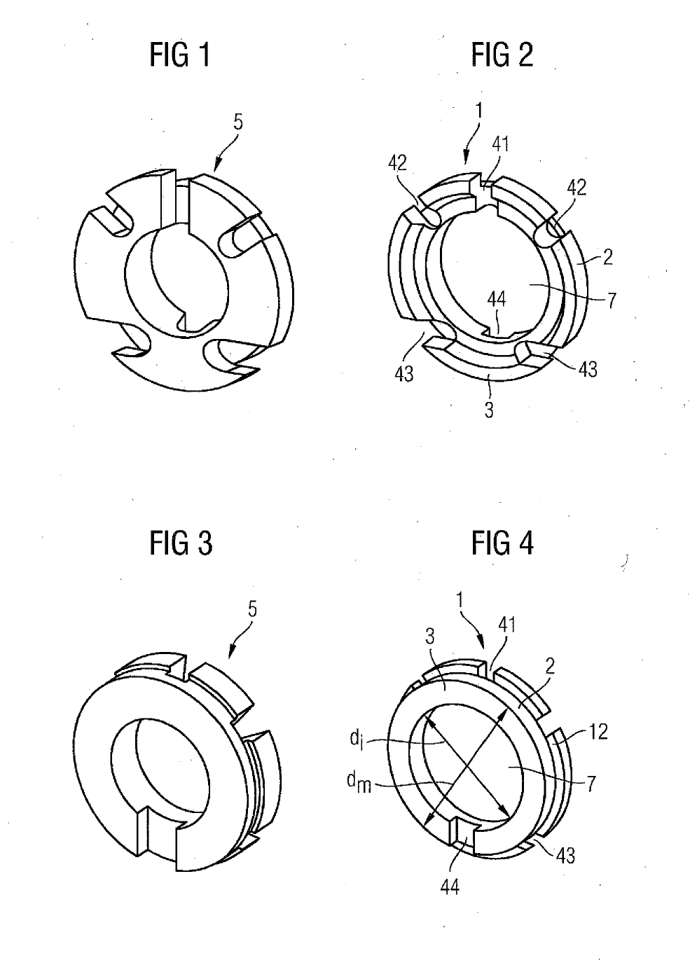

DE 10036975 A1 (Jatco Transtechnology Ltd.) 04.12.2001 describes in FIG. 1 an oil reservoir 16, which is retained by a track 15 acting as an oil dam. Roller bearing rollers 3 are immersed at least to some extent into the oil of the oil reservoir 16.

When the oil level inside the gearbox has fallen, oil retaining rings are also used to date i.a. to adjust a predetermined oil level in a bearing bore on a shaft which is sealed by a labyrinth seal and protrudes from a spur gear mechanism. Oil retaining rings are for example built into Flender planetary gears FZG of type H1SH, sizes 3 to 19, which are described in catalog Siemens MD 20.1 “Zahnradgetriebe, Gröβen 3-22 (Planetary gears, sizes 3-22)”, 2009 Edition. The oil retaining ring sits completely in a bearing bore of the gear. The base body of the oil retaining rings is cast. To set the oil level holes are inserted mechanically on the circumference of the ring. The oil flowing out via the radial holes must be taken away by milled grooves and separate holes provided therefor in the housing.

The object of the present invention is to specify a method for producing an improved oil retaining ring, an improved oil retaining ring and also a blank for producing such an oil retaining ring.

The object is achieved in accordance with the invention by a method with the features specified in claim 1. The inventive method for producing an oil retaining ring comprises the following steps: Primary forming of a blank which has a groove intended as an oil runout with an oil retaining edge formed in the groove; machining the blank on at least one circumferential surface and/or at least one plane surface to form a finished part with predetermined diameters or plane surfaces; and leaving the groove intended as an oil runout in the state obtained by primary forming on the finished part.

The object is likewise achieved in accordance with the invention by an oil retaining ring with the features specified in claim 4. The inventive oil retaining ring comprises at least one circumferential surface and/or plane surface which has a surface quality Rₐ≦3.2, and a groove intended as an oil runout, which has an oil retaining edge embodied in the groove and the surface of which is to be assigned to Category S1 of BNIF classification chart No. 359-01. The widely-used BNIF classification chart No. 359-01, to which reference is made in DIN EN 1370, is a technical recommendation of the Bureau de Normalisation des Industries de la Fonderie (=BNIF), obtainable from Editions Techniques des Industries des la Fonderie, 44 Avenue de la Division Leclerc, 92310 Sèvres, France.

Leaving a groove in the state obtained by primary forming results in a surface of the groove which is to be assigned to Category S1 of the BNIF classification chart No. 359-01.

Circumferential surface is to be understood as a curved surface which especially runs radially around the axis of the ring. Plane surface is to be understood as a plane surface which especially runs perpendicular to the axis of the ring.

The inventive oil retaining ring serves to set a defined oil level in a bearing, i.e. it has an oil retaining function. The oil retaining ring sits in a bearing bore of the housing and retains the oil in the bearing bore to a predetermined oil level and supplies dosed fresh oil to the bore and removes surplus oil. The oil flowing out via horizontal grooves from the oil retaining ring is taken away via holes and grooves in the gear housing. In addition the oil retaining ring, through its outer surfaces, which are also referred to as circumferential surfaces, can be used for centering a bearing cover and thus also a receiving bush and an outer labyrinth ring, via the bearing bore. In addition the oil retaining ring can take over axial positioning of the bearing and a redirection of axial bearing forces to the bearing cover, and can do this by a least one of its plane surfaces.

The invention is based on the knowledge that the oil retaining rings fulfill two functions which need absolutely different geometrical precisions. On the one hand the oil retaining rings position adjoining components exactly in relation to one another and do so to very close tolerances of a few hundredths of millimeters. On the other hand the oil retaining rings explicitly convey oil in and out via grooves.

The corresponding elements of the oil retaining rings which fulfill the respective function need absolutely different geometrical precisions. While the elements used for oil guidance, i.e. the grooves, merely have to be present and may not adversely affect the positioning function, the elements used for the positioning function must be highly accurate. The low precision of the oil guidance elements needed can be adhered to in any event by a primary forming function, preferably “sand casting”; the high precisions demanded for the positioning functions, e.g. as regards the roundness of the circumferential surfaces and the position of the plane surfaces in relation to one another, cannot.

On the inventive oil retaining rings each element is produced precisely with the accuracy and the production method corresponding to the accuracy which is necessary for its function. In accordance with the invention “over-qualified” methods for producing oil guidance elements are avoided since they make the finished product unnecessarily more expensive:
The grooves for oil guidance, already produced during primary forming with low or sufficient accuracy are “almost provided for free”, since the casting model present once creates them automatically in the casting process. The primary forming, preferably by sand casting, is the best possible method of producing the blank AND the oil guidance elements with sufficient accuracy.
For the elements of the oil retaining ring required for positioning (end face surfaces and outer surfaces) the accuracy able to be achieved by primary forming is far too low. They are therefore post processed by machining. Preferably the production method here is turning. There are even finer machining processes with which the surfaces involved could be produced. However once again these would be “over-qualified”, because they could achieve far greater accuracies than required but are also more expensive than necessary. Turning is the best possible production method for producing the required accuracy of the positioning elements of the oil retaining ring.

In accordance with the invention unnecessarily accurate and thus expensive production methods are replaced by sufficiently accurate and thus lower-cost variants. The grooves used for oil runout, which were previously “expensive” drilled holes are thus obtained “for free” in accordance with the invention since they are produced automatically during casting without a further production step having to be provided for this purpose. Sand casting and turning create basically different surface properties or structures.

By already producing functionally-relevant components or properties of the oil retaining ring—except for diameters and plane surfaces—during the primary forming stage, working steps in the subsequent machining of the oil retaining ring can be dispensed with. The setting of oil level is guaranteed by an offset oil retaining ring which is produced from a cast blank in which all grooves required for oil guidance are precast. The lower production outlay for mechanical processing, also for adjoining components, leads to shorter throughput and re-procurement times, a lower potential for errors and lower production costs, for adjoining components too such as the housing for example. A considerable saving in working time and material is thus able to be achieved by the present invention.

Advantageous embodiments and developments of the invention are specified in the dependent claims. In such cases the inventive method can also be developed in accordance with the dependent device claims and vice versa.

In accordance with a preferred embodiment of the invention the unprocessed state is created by casting a metallic blank of the oil retaining ring. In accordance with a preferred embodiment of the invention the primary forming is done by casting a melt in a casting mold. The primary forming is preferably done by sand casting. Primary forming of the oil retaining ring blank by casting has the advantage that, after provision of a casting mold, a large number of identical workpieces can be produced quickly and at low cost.

In accordance with a preferred embodiment of the invention the oil retaining ring includes at least two grooves, the surfaces of which are to be assigned to Category S1 of the BNIF classification chart No. 359-01. In such cases the at least two grooves comprise one or more of the following grooves: groove for an oil runout for pressurized lubrication, groove for an oil runout for unpressurized lubrication, groove for an emergency overflow. This offers the advantage that the setting of the oil level in a bearing bore receiving the oil retaining ring is guaranteed by an oil retaining ring that is produced from a cast blank in which grooves needed for oil guidance are already cast.

According to a preferred embodiment of the invention the oil retaining ring includes at least two grooves, the surfaces of which are to be assigned to Category S1 of the BNIF classification chart No. 359-01 and which are disposed symmetrically to a plane of symmetry of the ring. It is possible for two of the at least two symmetrical grooves to each have an oil retaining edge embodied in the groove and to run in a straight line transverse to the axis of the ring. This enables the oil to run out transverse to the axis of the shaft passage running through the center of the oil retaining ring. This new oil guidance means that previously necessary drilling and milling work on the housing is not necessary.

The one or more grooves for an oil runout preferably run horizontally and have an oil retaining edge.

According to a preferred embodiment of the invention the oil retaining ring comprises one or more grooves, the surfaces of which are to be assigned to Category S1 of the BNIF classification chart No. 359-01 and which are embodied so that the inflow and/or outflow of oil can take place exclusively via a bearing cover of a housing, which covers the oil retaining ring in relation to the housing outer space when the oil retaining ring is located in a position installed in a housing. The result able to be achieved by this is that the oil flowing into the oil retaining ring and also the oil flowing away from the oil retaining ring will be routed via the bearing cover. This new oil guidance means that previously necessary drilling and milling work on the housing is not necessary.

According to a preferred embodiment of the invention the at least one groove provided for oil guidance comprises two or more grooves which are disposed symmetrically to a plane of symmetry. A symmetrical arrangement of grooves enables different gear versions to be realized with the same oil retaining ring.

According to a preferred embodiment of the invention one or more grooves of the at least one groove is a groove for oil inflow with unpressurized lubrication and/or a groove with an oil retaining edge for an oil runout, wherein these one or more grooves, viewed in parallel to an axis of a shaft through-opening embodied in the oil retaining ring, overlap with corresponding grooves for oil inflow or oil runout of a bearing cover of the housing which covers the oil retaining ring in relation to the housing outer space when the oil retaining ring is located in a position installed in the housing. In this way use is made of the synergy between the oil retaining ring and the adjoining bearing cover.

According to a preferred embodiment of the invention the machining is undertaken by turning and/or milling. These machining methods allow a rapid and precise working of the blanks.

According to a preferred embodiment of the invention the oil retaining ring is in one piece.

A preferred development of the invention is a machine element, especially a gearbox, with a housing, with a shaft passing through a wall of the housing supported in bearings which is sealed by a non-contact shaft seal against the housing wall, and an oil retaining ring as described above, wherein the oil retaining rig is arranged in a bearing bore of the machine element and does not change its position and orientation relative to the housing wall.

With the machine element it is possible for the oil retaining ring to be disposed spaced away from rotating parts of the machine element. It is also possible with the machine element for the oil retaining ring to include a groove for an oil inflow for non-pressurized lubrication and/or a groove with an oil retaining edge for an oil runout, wherein these one or more grooves, viewed in parallel to the ring axis (6), overlap with corresponding grooves for the oil inflow or runout of a bearing cover of the housing which covers the oil retaining ring in relation to the housing outer space.

The object is also inventively achieved by a blank for producing an oil retaining ring, wherein the blank is embodied by primary forming, preferably casting and has at least one groove intended for oil guidance, which is embodied by the said primary forming. The blank serves as an initial product from which, by removal of material by means of machining on the at least one circumferential surface and/or at least one plane surface an oil retaining ring can be produced. Preferably in the machining of the blank the grooves already embodied in the blank are not machined but remain in an un-machined state, as was produced by the primary forming.

The invention is explained below on the basis of a number of exemplary embodiments with the aid of the enclosed drawing. In the drawing, in schematic diagrams and not true-to-scale:

FIGS. 1 and 2 show the side of a finished oil retaining ring (FIG. 2) facing towards the inside of the housing in an arrangement in a bearing bore and the same side of a corresponding blank (FIG. 1), in a perspective view in each case;

FIGS. 3 and 4 show the side of the finished oil retaining ring shown in FIG. 2 facing towards the bearing cover in an arrangement in a bearing bore (FIG. 4) and the same side of the corresponding blank (FIG. 3), in a perspective view in each case;

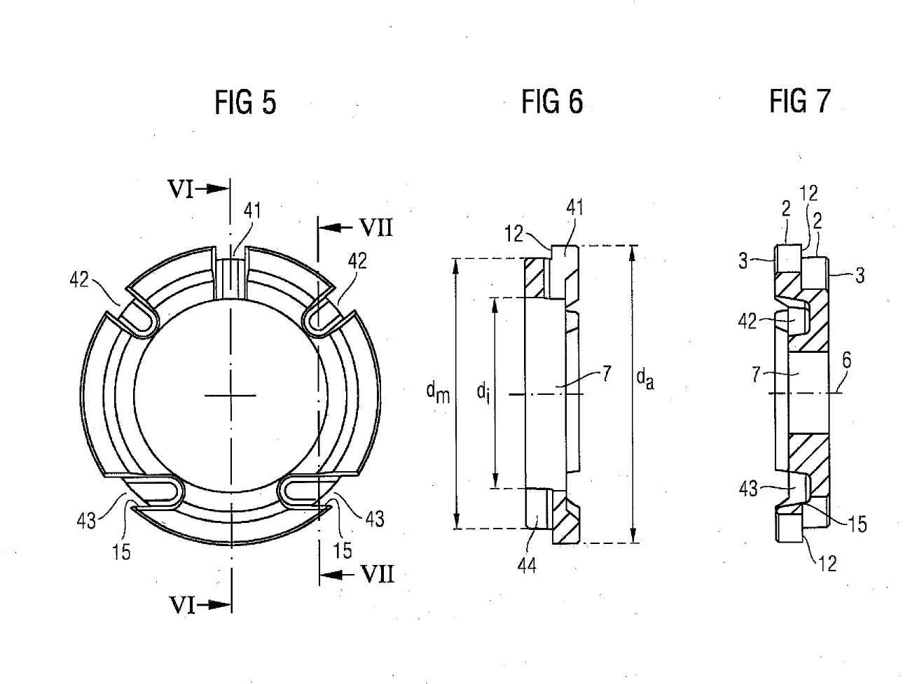

FIG. 5 shows a front view of the side of the oil retaining ring shown in FIGS. 2 and 4 facing towards the inside of the housing in an arrangement in a bearing bore;

FIGS. 6 and 7 show two sections VI, VII of the oil retaining ring shown in FIG. 5;

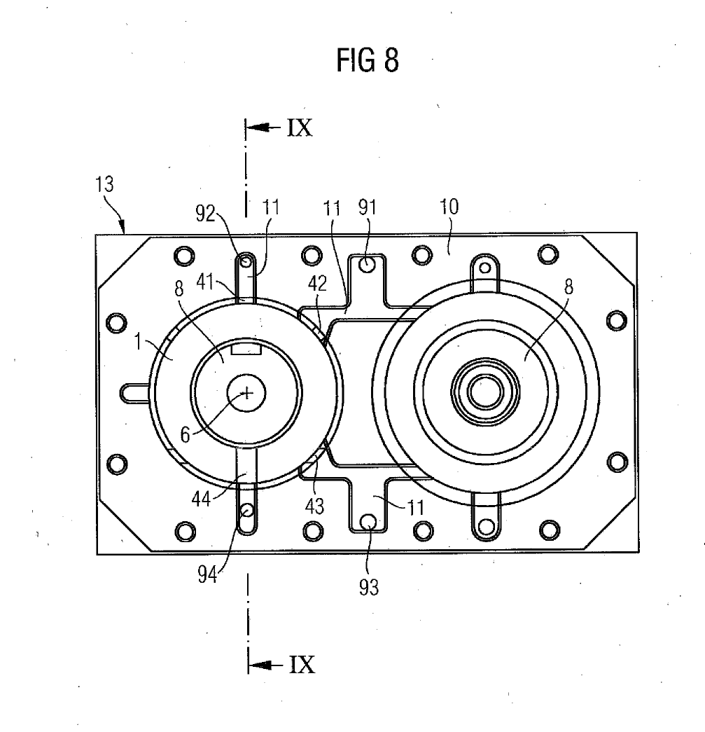

FIG. 8 shows a view of an oil retaining ring in a mounting position in a housing with bearing cover removed; and

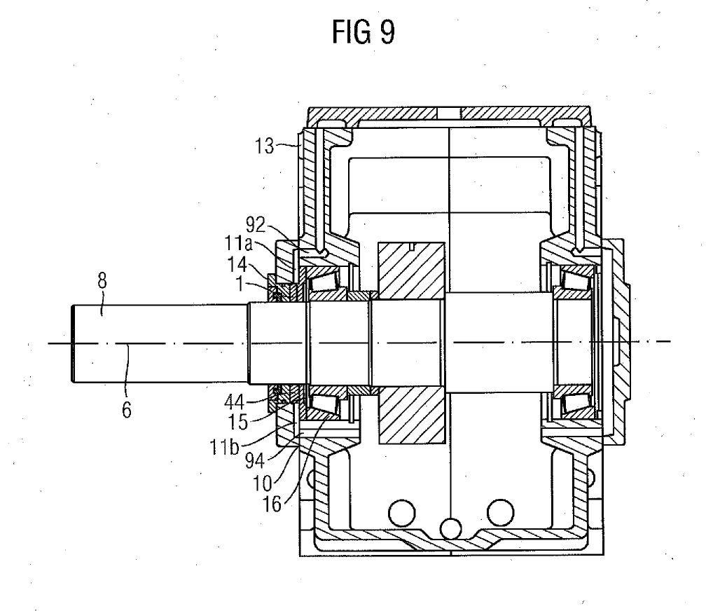

FIG. 9 shows a section IX of the housing shown in FIG. 8.

The oil retaining ring 1 shown in FIGS. 1 to 7 is intended to be disposed in a bearing bore of a bearing lubricated with a liquid lubricant such as oil. The oil retaining ring 1 is suitable for use in a gearbox, a motor or a machine for example which have shaft bearings lubricated with oil.

The oil retaining ring 1 has circumferential surfaces 2 and plane surfaces 3, 12 which are embodied by machining. A first plane surface 3 on the side facing towards the bearing cover forms a slotted ring running concentrically around an axis of rotation 6 of the oil retaining ring 1 with an internal ring diameter dᵢ and an external ring diameter dₘ. In this case the internal ring diameter dᵢ corresponds to the diameter of the circular ring opening 7 of the oil retaining ring 1. The ring opening 7 is used for the passage of a shaft. So that a ring-shaped air gap is embodied between the oil retaining ring 1 and a shaft passing through the oil retaining ring 1, the internal ring diameter dᵢ is slightly larger than the external diameter of the shaft. The oil retaining ring 1 is inserted with its external diameter dₐ into a bearing bore of the gearbox housing while the oil retaining ring 1 with the external ring diameter dₘ is inserted into a bearing cover of the gearbox housing.

A second plane surface 12 on the side facing towards a bearing cover, which is embodied between the outer ring diameter dₘ and and the outer diameter dₐ of the oil retaining ring 1 transmits bearing forces to the bearing cover. Through a circumferential surface 2 connecting the first and second plane surface 3, 12 a centering of the oil retaining ring 1 on insertion into a gearbox housing is facilitated.

Through its circumferential surfaces 2 the oil retaining ring can cause a centering of a bearing cover and thus of a receiving bush and an outer labyrinth ring over the bearing bore. In addition the oil retaining ring, through the second plane surface 12 facing towards the bearing cover and the plane surface 3 on the side facing towards the inside of the gearbox can take over an axial positioning of the bearing and a redirection of axial bearing forces to the bearing cover.

The oil retaining ring 1 also has grooves 41, 42, 43, 44 intended for oil guidance, which are left in an un-machined state which was produced by a primary forming of the blank 5 of the oil retaining ring.

The oil retaining ring 1 has a groove 41 for oil inflow with pressurized lubrication, two grooves 42 for an oil inflow with unpressurized lubrication, two grooves 43 for an oil runout and a groove 44 for an emergency overflow. The doubled grooves 42, 43 are symmetrically arranged to enable different gearbox versions to be realized. This makes it possible to produce different finished parts from the same blank.

The position of the oil retaining edges 15 of the horizontal grooves 43 is selected so that an oil retaining ring 1 can be used for two or more required oil levels, if necessary caused by different shaft bearings. This reduces the diversity of parts and thus warehousing costs as well.

The blank 5 shown in FIGS. 1 and 3 has a surface created by casting, which is thus to be assigned to category S1 of BNIF classification chart No. 359-01. In the blank 5 the surfaces on the circumferential surfaces 2 and the plane surfaces 3 and 12, which are specified in the finished part 1 shown in FIGS. 2 and 4, are formed with an overdimension, since they are yet to be post-processed by subsequent machining steps to the final dimension. The blank 5 already has the grooves 41, 42, 43 and 44, which are specified in the finished part 1 shown in FIGS. 2 and 4. In the machining steps which are executed on the blank 5 and which lead to the finished parts shown in FIGS. 2 and 4 only the circumferential surfaces 2 and the plane surfaces 3 and 12 are machined out of the blank 5, the grooves 41, 42, 43 and 44 however are left in the raw state created by casting, i.e. unmachined.

FIG. 8 shows a view of an oil retaining ring 1 in an installed position in a wall 13 of a gearbox housing. In order to show the interaction of oil retaining ring 1 and oil inflow and runout, the view of the oil retaining ring 1 is overlaid with the contours of a bearing cover 10, which during installation on the housing wall 13 covers the oil retaining ring 1. A shaft 8 is inserted through the shaft opening of the oil retaining ring 1, which is sealed by a labyrinth seal from the gearbox environment. The oil retaining ring 1 surrounding the shaft 8 sits in a bearing bore, which is fitted into a wall 13 of the gearbox housing. The housing wall 13 has a hole 91, through which oil is directed with unpressurized lubrication from the inside of the gearbox housing into an inflow groove 11, which is cast into an inner side of the bearing cover. From there the oil flows under the influence of gravity to a groove 42 of the oil retaining ring 1 which is intended for pressurized lubrication, and flows from there via this groove 42 to the bearing bore, where it serves to lubricate the shaft bearing.

Surplus oil in the shaft bearing flows out of the shaft bearing via the oil overflow 43 into a runout groove 11, which is cast into an inner side of the bearing cover 10. From there the oil is conveyed through the groove 11 to a further hole 93 in the housing wall 13, through which the oil flows back into the inside of the gearbox housing. From there the oil arrives via an immersion lubrication of rotating meshed parts at an oil collection container, from which the oil reaches the inflow groove 11. In this way a closed oil circuit and reliable lubrication of the shaft bearings is guaranteed.

The housing wall has a further hole 92 via which, with pressurized lubrication, oil can reach the groove 41 via a groove 11 for pressurized lubrication of the oil retaining ring 1. In addition a runout hole 94 is provided in the housing wall below groove 44 for emergency overflow of the oil retaining ring 1.

The grooves 41 to 44 in the oil retaining ring 1 overlap, viewed in parallel to an axis of a shaft opening embodied in the oil retaining ring 1, with the corresponding grooves 11 for the oil inflow or runout of the bearing cover 10 of the housing, which covers the oil retaining ring 1 in the direction towards the outer area of the housing. In this case the shaft axis 6 coincides with the ring axis of the oil retaining ring 1.

FIG. 9 shows a section IX along the ring axis 6 of an oil retaining ring 1, which sits in a bearing bore of a gearbox housing 13 and is covered by a bearing cover 10. A shaft 8 routed through a housing wall 13 is sealed by a labyrinth seal which is inserted into a receiving bush 14 fixed in the bearing cover 10.

The gearbox housing 13 has holes 92, 94 for inflow and runout of oil to a shaft bearing 16 in which a shaft 1 is supported. The oil conveyed out of the inside of the housing via a hole 92 for oil inflow for pressurized lubrication flows in a groove 11a embodied in the bearing cover 10 for pressurized lubrication to the bearing bore. There the lubricating oil is retained by the oil retaining ring 1 up to an oil retaining edge 15.

Also visible in the section is a groove 44 of the oil retaining ring 1 for an emergency overflow out of which the oil flows via a groove 11b for an emergency overflow embodied in the bearing cover 10 to a hole 94 in the gearbox housing. Via this hole 94 the oil gets back into the inside of the housing. The hole 94 has a further function: With a normal immersion lubrication it serves to equalize the pressure and/or an oil circulation when the bearing is conveying oil in the direction of the bearing cover. Immersion lubrication means that the oil level in the gearbox housing is high enough for at least one bearing, preferably all bearings, and at least one toothed first part, preferably all toothed parts, to be immersed in oil and shaft circumference surfaces with contact to shaft sealing rings to be touched by standing oil.

Although the invention has been illustrated and described in greater detail by the preferred exemplary embodiments, the invention is not restricted by the disclosed examples and other variations can be derived therefrom by the person skilled in the art, without departing from the scope of the invention.

What is claimed is:

1.-13. (canceled)

14. A method for manufacturing an oil retaining ring, comprising:
primary forming a blank with a groove intended as an oil runout and having an oil retaining edge; and
machining at least one circumferential surface or at least one plane surface of the blank to produce a finished part with predetermined diameters or plane surfaces, with the groove remaining on the finished part in a state obtained by the primary forming.

15. The method of claim 14, wherein the primary forming includes casting a metallic melt into a casting mold.

16. The method of claim 14, wherein the machining includes turning and/or milling.

17. An oil retaining ring, comprising a base body including at least one circumferential surface or plane surface, which has a surface quality Rₐ≦3.2, and a groove intended as an oil runout and having a surface classified in Category S1 of the BNIF classification chart No. 359-01, said groove having an oil retaining edge.

18. The oil retaining ring of claim 17, wherein the base body has at least two of said groove configured to assume a task selected from the group consisting of groove for an oil inflow with pressurized lubrication, groove for an oil inflow with unpressurized lubrication, and groove for an emergency overflow.

19. The oil retaining ring of claim 17, wherein the base body has at least two of said groove arranged symmetrically to a plane of symmetry of the base body.

20. The oil retaining ring of claim 19, wherein each of the at least two symmetrical grooves runs in a straight line transverse to an axis of the base body.

21. The oil retaining ring of claim 17, wherein the groove is configured to enable an inflow and/or runout of oil exclusively via a bearing cover of a housing, which bearing cover covers the oil retaining ring in a direction towards an outer area of the housing when the oil retaining ring is installed in the housing.

22. The oil retaining ring of claim 17, constructed as a single-piece structure.

23. A machine element, comprising:
a housing;
a shaft sized to extend through a wall of the housing;
bearings configured to support the shaft;
a non-contact shaft seal configured to seal the shaft against the wall of the housing; and
an oil retaining ring arranged in a bearing bore of the machine element such as to be immobile in relation to the wall of the housing.

24. The machine element of claim 23, constructed in the form of a gearbox.

25. The machine element of claim 23, wherein the oil retaining ring is arranged at a distance from rotating parts of the machine element.

26. The machine element of claim 23, wherein the oil retaining ring includes at least one groove selected from the group consisting of groove configured for inflow for non-pressurized lubrication, and groove configured with an oil retaining edge for an oil runout, said groove, when viewed in parallel to an axis of the oil retaining ring, overlapping with a corresponding groove for the oil inflow or runout of a bearing cover of the housing which covers the oil retaining ring in relation to an outer area of the housing.

27. The machine element of claim 23, wherein the oil retaining ring has a base body including at least one circumferential surface or plane surface, which has a surface quality Rₐ≦3.2, and a groove intended as an oil runout and having a surface classified in Category S1 of the BNIF classification chart No. 359-01, said groove having an oil retaining edge.

28. The machine element of claim 27, wherein the base body has at least two of said groove configured to assume a task selected from the group consisting of groove for an oil inflow with pressurized lubrication, groove for an oil inflow with unpressurized lubrication, and groove for an emergency overflow.

29. The machine element of claim 27, wherein the base body has at least two of said groove arranged symmetrically to a plane of symmetry of the base body.

30. The machine element of claim 29, wherein each of the at least two symmetrical grooves runs in a straight line transverse to an axis of the base body.

31. The machine element of claim 27, wherein the groove is configured to enable an inflow and/or runout of oil exclusively via a bearing cover of a housing, which bearing cover covers the oil retaining ring in a direction towards an outer area of the housing when the oil retaining ring is installed in the housing.

32. The machine element of claim 23, wherein the oil retaining ring is constructed as a single-piece structure.

33. A blank for producing an oil retaining ring, said blank produced by primary forming and having at least one groove intended for oil guidance and realized during said primary forming.

34. The blank of claim 33, produced by casting.
